(19) United States
(12) Patent Application Publication
(10) Pub. No.: US 2007/0181080 A1
(43) Pub. Date: Aug. 9, 2007

(54) Animal protective collar

(76) Inventor: Chad Eugene Gibson, Carlsbad, CA (US)

Correspondence Address: ROBERT W. SMTIH, 35 NORTH HARWOOD AVENUE, UPPER DARBY, PA, 19082, US

(21) Appl. No.: 11/726,292

(22) Filed: Mar. 20, 2007

Related U.S. Application Data
(63) Continuation-in-part of application No. 11/388,521, filed on Mar. 24, 2006.
(60) Provisional application No. 60/665,475, filed on Mar. 28, 2005.

(51) Int. Cl. A01K 27/00; A01K 15/04

(52) U.S. Cl. 119/815

(57) ABSTRACT

An animal protective collar which utilizes a flexible walled ring that is inflatable. The ring is split defining a gap which is expandable to facilitate installation on the neck of the animal. Once installed on the neck of the animal, a fastener assembly extends across the gap to secure the ring in a close conforming manner to the animal's neck. Collar loops are mounted on the ring that permit the attachment of the ring to the animal identification collar that the animal normally wears.

### REFERENCE TO PRIOR APPLICATION

This application is a continuation-in-part of application Ser. No. 11/388,521, filed Mar. 24, 2006, entitled ANIMAL PROTECTIVE COLLAR by Chad Eugene Gibson, which was filed originally as a provisional application 60/665,475, filed Mar. 28, 2005, entitled ANIMAL PROTECTIVE COLLAR by Chad Eugene Gibson.

### BACKGROUND OF THE INVENTION

1. Field of the Invention

The present invention relates generally to an animal protective collar, and more particularly to a collar which is designed to protect the animal against a injury inflicted by the animal by chewing, scratching or biting.

2. Description of the Prior Art

When dogs and cats have an injury or rash, the animal will invariably scratch with its legs or bite the injury or rash. In case of an injury, when the bandages have been located about the injury, it is common for the animal to completely tear off the bandages. If the injury or rash is in conjunction with the head of the animal, the animal will use its leg to constantly tear at the injury or rash.

In the past, in order to prevent this, there has been designed a rigid sheet material collar, about six inches to one foot wide, that is in the shape of a split ring disc that has a cone shape. The split portion of the disc is to be expanded and installed about the neck of the animal and then the split portions of the disc are then secured together. The disc will function to prevent the dog from biting its torso and legs and at the same time also prevent the legs from being usable to scratch the head and neck of the animal.

These animal protective collars of the prior art have had certain disadvantages. Because the collars are rigid, if the animal comes into contact with furniture, then the furniture will become marked or scraped. Repair of the furniture becomes a necessity. Also, the animal can, by moving against the collar, cause the collar to deflect or bed, which can result in the animal then being able to inflict itself with an injury. Also, these prior art collars frequently dirty and the collars are not washable.

Prior art has provided collars that have sought to meet the same need have provided collars that are one size fits all, whereas the instant invention provides different sizes based on the depth/body height of animal and provides a diameter/circumference ratio according to the weight of the animal. Furthermore, the instant invention uses the animal's existing as a securing device.

U.S. Pat. No. 6,659,046 to Schmid et al. relies on the diameter and/or the circumference of the device to prevent animals from reaching parts of their anatomy that have medical implications. There is no claim to reduce cone size. The cone size of the Schmid et al. invention causes excess bumping into furniture, walls, people and other objects because of its excessive size. With the instant invention, the inflation of the device provides the basis for compact storage when the device is not in use. Its inflatability also provides for it being one size fits all.

The instant invention has a reduced diameter/circumference ratio and a thicker depth/body height ratio that comfortably keeps the animal's head in position, like a soft pillow. The instant invention is attached to the animal's collar rather than having a top and bottom that is secured to a shawl as in the Schmid et al. invention.

The instant invention is typically made of 20 mil plastic containing an inner tube or bladder. The device is made from a custom mold and the cover is made of a bite and scratch resistant synthetic material.

### SUMMARY OF THE INVENTION

The preferred embodiment of the present invention provides for a soft, mildly protruding animal collar for denying the animal access to medically sensitive body parts comprising a ring-shaped flexible walled housing having a split which forms a gap in the ring, the housing having an internal chamber, the ring having a center hole, a fastener assembly mounted on the ring and extending across the gap, the fastener assembly to releasably secure the ring together across the gap, an access opening formed in the housing; an inflatable flexible walled tube inserted through the access opening into the internal chamber and spread out within the internal chamber with the tube substantially occupying the entire the internal chamber, an inflation valve mounted on the tube, pressurized air adapted to be conducted through said valve to inflate said tube to press said tube tightly against the ring while the ring expands to an expanded position, the tube being deflatable which causes both the tube and the ring to assume a collapsed position; and the center hole has a walled surface which is part of the housing, a plurality of collar loops mounted on the walled surface, the collar loops adapted to provide an interconnection with an animal identification collar.

The above embodiment can be further provided by defining that the fastener assembly including an elongated strap which utilizes a pair of engaging pads which function as a securement to close the fastener assembly.

The above embodiment can be further modified by defining that the collar has a reduced diameter/circumference ratio and a thicker depth/body height ratio.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is an isometric view showing the head of a dog on which has been installed the animal protective collar of the present invention.

FIG. 2 is a top elevational view of the animal protective collar of the present invention showing it in the installed position.

FIG. 3 is a side edge view of the animal protective collar of the present invention taken along line 3-3 of FIG. 2.

FIG. 4 is a cross-sectional view through the animal protective collar of the present invention taken along line 4-4 of FIG. 2.

### DETAILED DESCRIPTION OF A PREFERRED EMBODIMENT

Referring particularly to the drawings, there is shown in FIG. 1 the head 10 of a dog and a neck 12. Mounted on the neck 12 is the animal protective collar 14 of this invention. The collar 14 includes a split ring 16 which defines an exterior housing. The split ring 16 is to be constructed of a flexible, walled material with generally a polyethylene plastic bag being preferable. However, other types of plastic could certainly be used. A typical thickness would be a few thousandths of an inch for the split ring 16. The split ring 16 has a gap area 18 and a center hole 20. The center hole 20 has a wall surface 22.

Formed within the split ring 16 is an access opening 24 which is capable of being closed by a zipper 26. The access opening 24 provides access into an internal chamber 28 contained within the ring 16. Located within the internal chamber 28 in a loose fitting manner is a tube 30. The tube 30 is also flexible walled and is formed of plastic, again polyethylene being preferred, and tube 30 has mounted in its sidewall thereof an inflation valve 32. The inflation valve 32 extends outwardly through hole 34 formed within split ring 16. The user is to receive the collar 14 in a collapsed configuration and the user is to open the inflation valve 32 and blow through the valve 32 filling the interior chamber 36 of the tube 30 to where the tube 30 completely expands substantially filling the internal chamber 28, as shown in FIG. 4 of the drawings. Once the tube 30 and the split ring 16 are completely expanded to a width of around four to five inches, as shown in the drawings, the inflation valve 32 is then to be closed thereby maintaining the collar 14 in the expanded position.

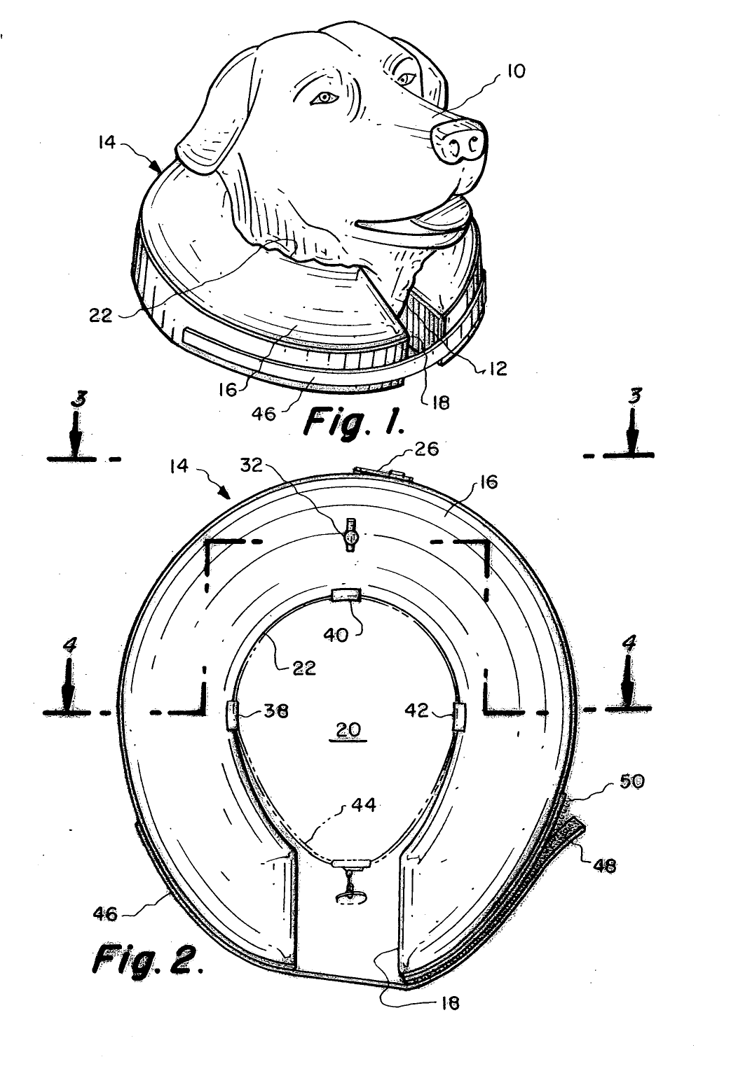

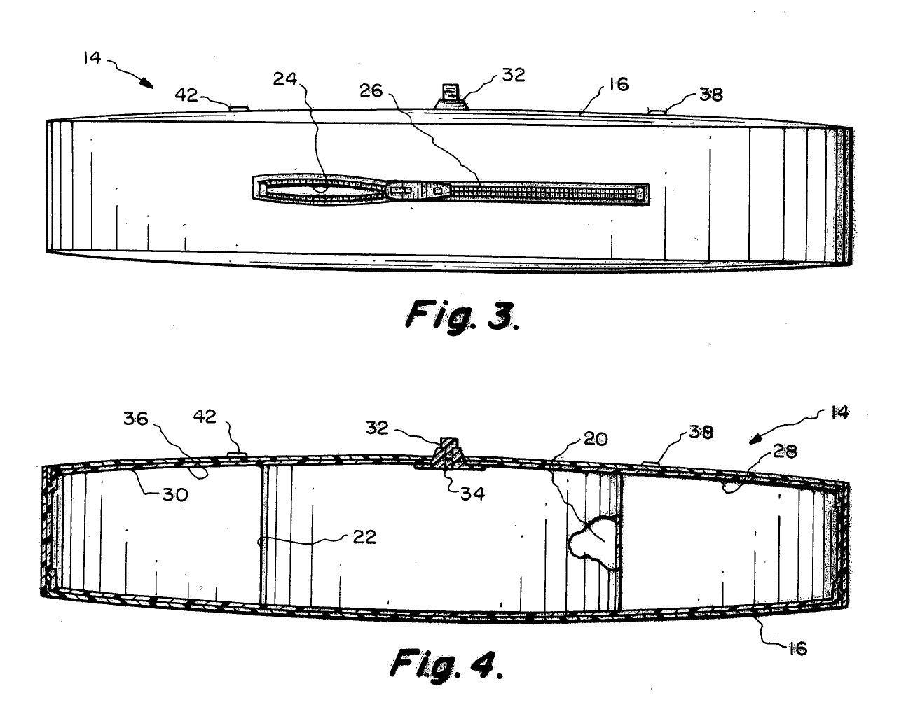

Mounted on the wall surface are a plurality (three in number) of collar loops 38, 40 and 42. Each of the collar loops 38, 40 and 42 is formed by a little strip of fabric that is adhesively secured or sewn to the housing of the split ring 16. The purpose of the collar loops 38, 40 and 42 is to provide that the animal identification collar 44 that the animal would normally wear be taken off the animal and that the collar 44 be threaded through the loops 38, 40 and 42, as shown in FIG. 2 of the drawings. The gap area 18 is then expanded the collar 44 reinstalled in a position about the neck of the animal and then fastened as normal. The housing of the split ring 16 is now secured to the collar 44 making sure it will not accidentally become dislodged from its installed position.

In order to be sure that the collar 14 is snugly locate about the neck 12 of the animal, there is mounted a strap 46 on the housing of the split ring 16 to one side of the gap area 18. The inside surface of the strap 46 includes a securing device, such as a pad 48 of mass of tiny hooks. Fixedly mounted on the housing of the split ring 16 on the opposite side of the gap area 18 is a pad 50 which includes a mass of tiny eyelets. During installation of the collar 14 on the neck 12 of the animal, the strap 46 is disconnected from the pad 50 so that the animal's neck can be slid through the gap area 18. Once the neck 12 of the animal is located in conjunction with the center hole 20 and the collar 44 is now reconnected, the strap 46 is then pulled tightly and pad 48 secure to pad 50. It is to be understood that the mass of tiny eyelets could be located on the pad 48 and the pass of tiny hooks could be on the pad 50. This type of connection securement is commonly sold under the trade name of VELCRO®.

With the collar 14 installed as shown in FIG. 1, the animal is now prevented from injuring itself by biting or by scratching, at least from scratching in the area of the head 10 of the animal. It is to be understood that the collar 14 can be disconnected from the neck 12 by merely disengaging of pads 48 and 50 and disconnecting the collar 44. By opening of inflation valve 32, the pressurized air contained within the interior chamber 30 can be removed and the collar 14 can be folded and stored away. Also, the collar 14 could be washed if such is dirty. It is to be understood that the collar 14 can be readily used reused at any time.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

What is claimed is:

1. A soft, mildly protruding animal collar for denying said animal access to medically sensitive body parts comprising:
a ring-shaped flexible walled housing having a split which forms a gap in said ring, said housing having an internal chamber, said ring having a center hole, a fastener assembly mounted on said ring and extending across said gap, said fastener assembly to releasably secure said ring together across said gap, an access opening formed in said housing; an inflatable flexible walled tube inserted through said access opening into said internal chamber and spread out within said internal chamber with said tube substantially occupying the entire said internal chamber, an inflation valve mounted on said tube, pressurized air adapted to be conducted through said valve to inflate said tube to press said tube tightly against said ring while said ring expands to an expanded position, said tube being deflatable which causes both said tube and said ring to assume a collapsed position; and
said center hole has a walled surface which is part of said housing, a plurality of collar loops mounted on said walled surface, said collar loops adapted to provide an interconnection with an animal identification collar.

2. The animal collar as defined in claim 1 wherein said fastener assembly including an elongated strap which utilizes a pair of engaging pads which function as a securement to close said fastener assembly.

3. The animal collar as defined in claim 1 wherein said collar has a reduced diameter/circumference ratio and a thicker depth/body height ratio.
